(19) United States
(12) Patent Application Publication
(10) Pub. No.: US 2023/0004906 A1
(43) Pub. Date: Jan. 5, 2023

(54) SYSTEM AND METHODS FOR AUTOMATED GENERATION OF DISPATCH SCHEDULE

(71) Applicant: Infosys Limited, Bangalore (IN)

(72) Inventors: Antony Arokia Durai Raj K, Bangalore (IN); Anup Mohan Dugane, Pune (IN); Harsh Goyal, Jaipur (IN); Manikandan Vandavasi, Chennai (IN); Aroosa Shaikh, Mumbai (IN)

(21) Appl. No.: 17/514,920

(22) Filed: Oct. 29, 2021

(30) Foreign Application Priority Data
Jun. 30, 2021 (IN) 202141029395

(51) Int. Cl. G06Q 10/06; G06Q 10/08; G06Q 30/02; G06N 3/12

(52) U.S. Cl. CPC G06Q 10/06315; G06Q 10/0633; G06Q 10/087; G06Q 30/0202; G06N 3/126

(57) ABSTRACT

A method and/or system for automated generation of dispatch schedule in warehouse outbound operations is disclosed. The method comprising, receiving configuration data comprising information about a warehouse and one or more stores. A variation in demand pattern and frequency pattern for the one or more stores is determined and a weighted score is calculated based on the determined variations. One among the plurality of customized algorithms is selected dynamically based on the calculated weighted score. A dispatch schedule for the warehouse is determined by executing the customized algorithm and the determined dispatch schedule is displayed graphically at a computing device of the user for execution in real-world scenario.

This application claims the benefit of Indian Patent Application Serial No. 202141029395 filed Jun. 30, 2021, which is hereby incorporated by reference in its entirety.

### FIELD

The present technique relates to automated systems. More specifically, the present technique relates to automated dispatch scheduling in warehouse outbound operations.

### BACKGROUND

Inbound and outbound operations are the two key components of a healthy supply chain. Supply chain efficiencies rely on efficient inbound and outbound operations. Outbound operations are the actions required to get the final inventory/goods delivered to the end points such as receiving orders, checking, packing, and shipping. With ineffective logistic process, companies have tough times sourcing products and getting products delivered to the end points. There are few tools available which focus more on the managerial and operational part of the problem. For e.g. there are transportation management tools which aid in tracking and executing the delivery orders; however, the manager carries out the planning manually. Most of the tools focuses on warehouse management solutions. Intelligent tools for delivery/dispatch planning catering tailor made requirements specific to problem contexts are lacking. Generally, in small scale firm the dispatch planning happens manually. Manual process leads to slow reaction to changing demand or other variations that may occur and leads to sub optimal planning. Hence, there is a need of an efficient system which can address the above-mentioned problems.

### SUMMARY

Presently, the dispatch planning as defined in the background section, is being performed manually or in silos leading to sub-optimal planning, delays in dispatch and fluctuations in warehouse throughput. In certain cases, it is performed using legacy rule-based systems.

Disclosed technology overcomes the problem through a system, a method and/or non-transitory computer readable storage medium for automated generation of dispatch schedule for warehouse outbound operations, as disclosed in various embodiments of the present disclosure.

In one aspect, a computer implemented method for automated generation of dispatch schedule is disclosed and the method comprising, receiving a configuration data from a user, the configuration data comprising information about a warehouse and one or more stores such as count of number of stores, count of number of warehouses, a warehouse-store mapping information and a forecasted demand for each of the one or more stores for a horizon. Variations in demand pattern and variations in frequency pattern of the one or more stores is determined and a weighted score is calculated based on the determined variations. At least one of plurality of customized models is selected dynamically based on the calculated weighted score. The plurality of customized models comprises a genetic model, a heuristic model, and a mixed linear programming model. A dispatch schedule for the warehouse may be generated by executing the selected at least one of the plurality of customized models and the determined dispatch schedule is displayed graphically at a computing device of the user.

When the selected at least one of plurality of customized models is the genetic model, the step of generating dispatch schedule comprises, composing one or more chromosomes for plurality of combination of a delivery pattern and a quantity of inventory to be delivered from the warehouse to the one or more stores, identifying a best fit chromosome from the one or more chromosomes by generating one or more offspring of the one or more chromosomes and eliminating one or more mutated chromosomes from the one or more chromosomes. The delivery pattern for one or more chromosomes is at least one of plurality of combinations comprising at least one store, at least one warehouse and a frequency of delivery of inventory to one or more stores. The delivery pattern and the quantity of items of the best fit chromosome are displayed as a dispatch schedule at the computing device to the user.

In another aspect, an automated dispatch scheduling system is disclosed and the system at least one processor and at least one memory unit operatively coupled to the at least one processor, having instructions stored and when executed by the at least one processor, causes the at least one processor to receive a configuration data from a user, the configuration data comprising information about a warehouse and one or more stores such as count of number of stores, count of number of warehouses, a warehouse-store mapping information and a forecasted demand for each of the one or more stores for a horizon. Variations in demand pattern and variations in frequency pattern of the one or more stores is determined and a weighted score is calculated based on the determined variations. At least one of plurality of customized models is selected dynamically based on the calculated weighted score. The plurality of customized models comprises a genetic model, a heuristic model, and a mixed linear programming model. A dispatch schedule for the warehouse may be generated by executing the selected at least one of the plurality of customized models and the determined dispatch schedule is displayed graphically at a computing device of the user.

When the selected at least one of plurality of customized models is the genetic model, the step of generating dispatch schedule comprises, composing one or more chromosomes for plurality of combination of a delivery pattern and a quantity of inventory to be delivered from the warehouse to the one or more stores, identifying a best fit chromosome from the one or more chromosomes by generating one or more offspring of the one or more chromosomes and eliminating one or more mutated chromosomes from the one or more chromosomes. The delivery pattern for one or more chromosomes is at least one of plurality of combinations comprising at least one store, at least one warehouse and a frequency of delivery of inventory to one or more stores. The delivery pattern and the quantity of items of the best fit chromosome are displayed as a dispatch schedule at the computing device to the user.

In yet another aspect, a non-transitory computer readable medium having stored thereon instructions for automated generation of dispatch schedule is disclosed, the non-transitory computer readable medium comprising machine executable code which when executed by at least one processor, causes the at least one processor to perform steps comprising receiving a configuration data from a user, the configuration data comprising information about a warehouse and one or more stores such as count of number of stores, count of number of warehouses, a warehouse-store mapping information and a forecasted demand for each of the one or more stores for a horizon. Variations in demand pattern and variations in frequency pattern of the one or more stores is determined and a weighted score is calculated based on the determined variations. At least one of plurality of customized models is selected dynamically based on the calculated weighted score. The plurality of customized models comprises a genetic model, a heuristic model, and a mixed linear programming model. A dispatch schedule for the warehouse may be generated by executing the selected at least one of the plurality of customized models and the determined dispatch schedule is displayed graphically at a computing device of the user.

When the selected at least one of plurality of customized models is the genetic model, the step of generating dispatch schedule comprises, composing one or more chromosomes for plurality of combination of a delivery pattern and a quantity of inventory to be delivered from the warehouse to the one or more stores, identifying a best fit chromosome from the one or more chromosomes by generating one or more offspring of the one or more chromosomes and eliminating one or more mutated chromosomes from the one or more chromosomes. The delivery pattern for one or more chromosomes is at least one of plurality of combinations comprising at least one store, at least one warehouse and a frequency of delivery of inventory to one or more stores. The delivery pattern and the quantity of items of the best fit chromosome are displayed as a dispatch schedule at the computing device to the user.

The system, the method, and/or the non-transitory computer readable storage medium disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one or more embodiments.

FIG. 2 is an architecture diagram illustrating various components of the automated dispatch scheduling system to optimize warehouse outbound operations, according to one or more embodiments.

FIG. 2A is an architecture diagram illustrating the communication between stores, warehouse, and the automated dispatch scheduling system, according to one or more embodiments.

FIG. 3 is a flowchart illustrating sequence of steps of computer implemented method executed by the automated dispatch scheduling system, according to one or more embodiments.

FIG. 4 is an exemplary graphical illustration of classification of demands based on the variability, according to one or more embodiments.

FIG. 5 is a screenshot illustrating a user interface to receive inputs on various parameters from the user and the simulated graph indicating the variations, according to one or more embodiments.

FIG. 6 illustrates the graphical representation of dispatch schedule plan or supply pattern before optimization, according to one or more embodiments.

FIG. 6A illustrates a graphical representation of dispatch schedule plan or supply pattern after optimization by the automated dispatch scheduling system, according to one or more embodiments.

FIG. 7 illustrates a graphical representation depicting daily aggregated demand from the stores which is before the optimization and generation of dispatch schedule plan by the automated dispatch scheduling system, according to one or more embodiments.

FIG. 7A illustrates a graphical representation depicting the optimized total quantity to be dispatched from the warehouse as generated by the automated dispatch scheduling system, according to one or more embodiments.

FIG. 8 is a process flow diagram illustrating sequence of steps executed by the optimizer (system) to generate dispatch schedule plan using a custom genetic algorithm, according to one or more embodiments.

FIG. 9 illustrates a exemplary chromosomes generated using a custom genetic algorithm, according to one or more embodiments.

FIG. 10 illustrates representation of parent chromosomes and the offspring using the custom genetic algorithm, according to one or more embodiments.

FIG. 11 is a tabular representation of exemplary inputs, variations and the determined VSPDF score, according to one or more embodiments.

FIG. 11A illustrates a dispatch schedule generated through custom genetic algorithm and the exemplary chromosome depicting the dispatch schedule plan, according to one or more embodiments.

FIG. 12 is a process flow diagram illustrating method executed by the automated dispatch scheduling system, according to one or more embodiments.

Other features of the present embodiments will be apparent from the accompanying drawings and from the detailed description that follows.

### DETAILED DESCRIPTION

By way of example, one of the exemplary objectives of examples of this technology is to overcome the technical problem mentioned in the background section through a system for automated dispatch scheduling in warehouse outbound operations as described in various embodiments of the present disclosure.

In supply chain management or inventory management, stores and warehouses are crucial as they facilitate movement of inventory to fulfill the demands in the market. In retail, demand forecasting is the practice of predicting which and how many products will customers buy over a specific period. Demand forecasting is typically done using historical data as well as external insights such as consumer trend, inflation, per capita income, employment index etc. and internal insights such as seasonality and trends of historical sales data available at store level. Forecasting helps retailers understand when they need to order new inventory from warehouse, and how much they need to procure/order. From warehouse perspective, an outbound side refers to the transport of inventory from the warehouse to stores. Based on the forecasted demand from the store, the warehouse needs to plan the delivery. The fact that one warehouse handles the request from multiple stores and one company may have various such stores, the outbound operation becomes complex as the supply chain network grows. Due to highly varying demand, the warehouses needed to act swiftly, in real-time so that the operations don't halt.

The present scenario comprises a network wherein each store is catered by a single warehouse. The planning process for such a scenario comprises developing a daily dispatch schedule from warehouses to stores. The dispatch schedule must adhere to many constraints like, the dispatch schedule should meet the store demands (SLA should be taken care) else it may lead to loss in sales. Typically, a store cannot receive the dispatch on all days of a week. Also, there are restrictions on the number of dispatches a store can receive in one week. Another constraint is that there may be labor availability/throughput restrictions at the warehouse. This planning process typically is an NP-hard problem.

Warehouse managers or production planners plan for the workforce to carry out the day-to-day operations in the facility. The challenge is to arrive at the schedule to handle daily outbound product flows. Generally, due to high variability in the demand and product outflow from the warehouse, workforce requirement is inconsistent. This may result in overtime or hiring of contractual labor to manage the surplus workload or no-work or firing on some other days. The present technique will make the dispatch scheduling far more competitive and dynamic with the changing business scenarios.

The main objective of the present technique is to generate an implementable output for throughput of the warehouse with minimal variation across the planning horizon through an ensemble approach. The disclosed technique provides a system for processing and generation of dispatch schedule that caters to the demand of every immediate downstream store that is served by the warehouse considering forecasted demand. The factors such as number of stores to be served by a warehouse and type of demand at the store, pattern and frequency of dispatch requested by the stores, and lead time from warehouse to store may affect the complexity of the problem. As a part of solution, the demand may be classified as smooth, intermittent, erratic, and lumpy based on statistical analysis of the demand. In the next part of the solution, the routes to each store/demand center are generated based on, hours of service, and other multiple constraints, which are described in detail in subsequent paragraphs of the present disclosure.

In one or more embodiments, a system, a computer implemented method and/or computer readable storage medium for automated generation of dispatch schedule is disclosed. The method comprising, receiving a configuration data from a user, the configuration data may comprise information about a warehouse and one or more stores such as count of number of stores, count of number of warehouses, a warehouse-store mapping information and a forecasted demand for each of the one or more stores for a horizon. Variations in demand pattern and variations in frequency pattern of the one or more stores may be determined and a weighted score may be calculated based on the determined variations. At least one of plurality of customized models may be selected dynamically based on the calculated weighted score. The plurality of customized models comprises a genetic model, a heuristic model, and a mixed linear programming model. A dispatch schedule for the warehouse may be generated by executing the selected at least one of the plurality of customized models and the determined dispatch schedule may be displayed graphically at a computing device of the user.

When the selected at least one of plurality of customized models is the genetic model, the step of generating dispatch schedule may comprise, composing one or more chromosomes for plurality of combination of a delivery pattern and a quantity of inventory to be delivered from the warehouse to the one or more stores, identifying a best fit chromosome from the one or more chromosomes by generating one or more offspring of the one or more chromosomes and eliminating one or more mutated chromosomes from the one or more chromosomes. The delivery pattern for one or more chromosomes may be at least one of plurality of combinations comprising at least one store, at least one warehouse and a frequency of delivery of inventory to one or more stores. The delivery pattern and the quantity of items of the best fit chromosome may be displayed as a dispatch schedule at the computing device to the user.

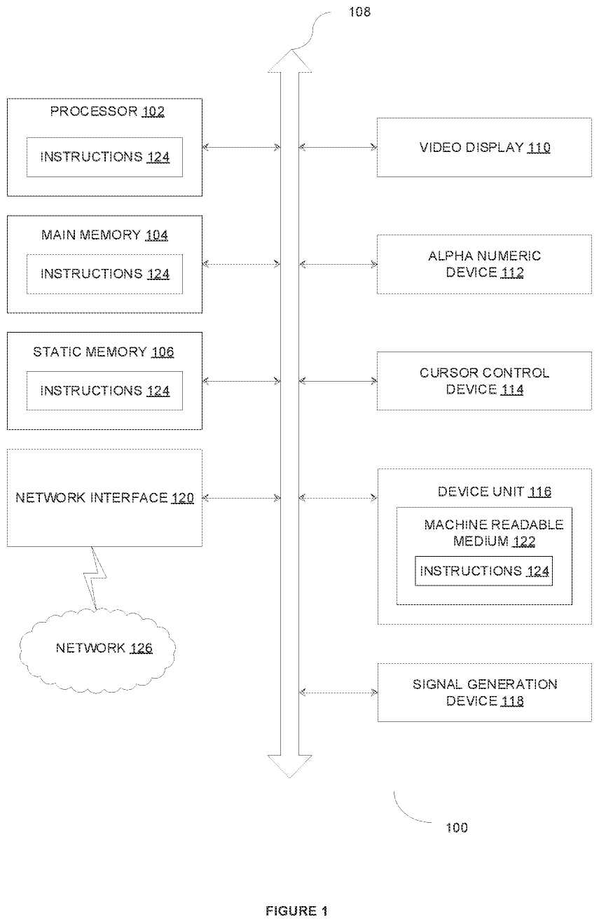

FIG. 1 is a diagrammatic representation of a machine and/or data processing device capable of processing a set of instructions to perform any one or more of the methodologies herein, according to one embodiment. The machine and/or the data processing device in the example form, comprises a computer system 100 within which a set of instructions, for causing the machine to perform any one or more of the methodologies discussed herein, may be executed. In various embodiments, the machine operates as a standalone device and/or may be connected (e.g., networked) to other machines.

A machine may be a personal computer (PC), laptop or an embedded system and/or any machine capable of executing a set of instructions (sequential or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker), and a network interface 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104, within the static memory 106 and/or within the processor 102 during execution thereof by the computer system 100, the main memory 104 and the processor 102 also constituting machine-readable media.

The instructions 124 may further be transmitted and/or received over a network 126 via the network interface 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical media, and magnetic media.

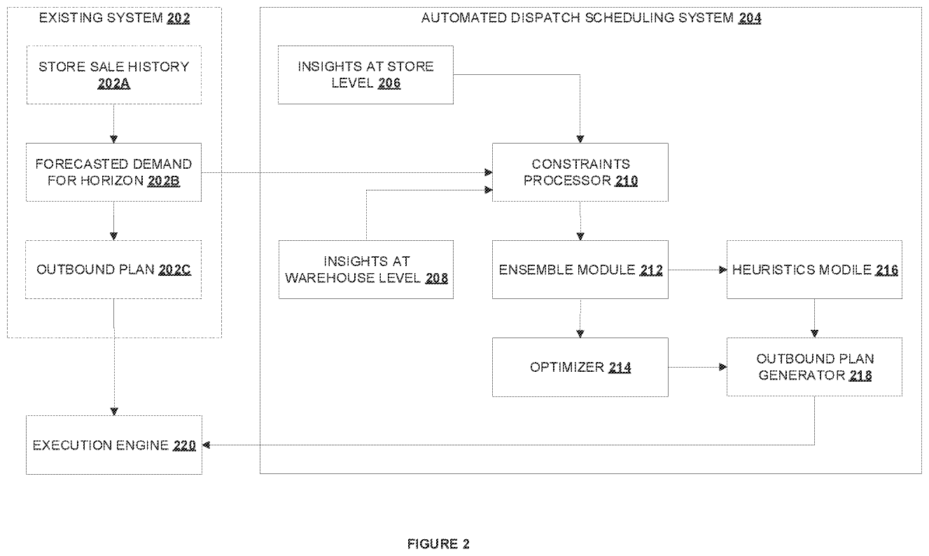

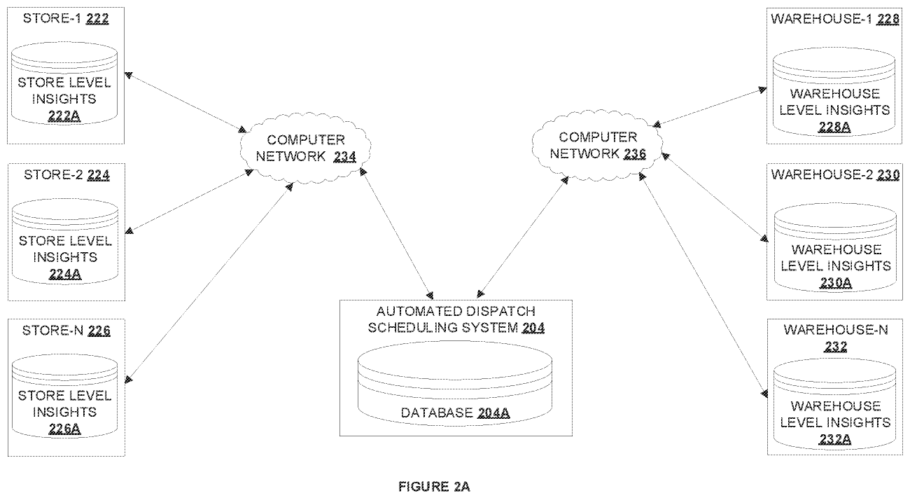

FIG. 2 is an architecture diagram illustrating various components of the automated dispatch scheduling system to optimize warehouse outbound operations, according to one or more embodiments. The system illustrates existing methodology/system 202 (represented in dotted/dash lines) along with the disclosed improvement in the technology. The existing system 202 comprises accessing store sale history 202A and the forecasted demand for horizon 202B, based on which the outbound plan 202C are devised manually and then the resource allocation is performed through execution engine 220. The present solution overcomes the above-mentioned problem through an algorithm driven automated dispatch scheduling system 204.

In one or more embodiments, the automated dispatch scheduling system 204 comprises one or more components, but not limited to constraints processor 210, ensemble module 212, optimizer 214, heuristics module 216 and outbound plan generator 218. The constraints processor 210 may be configured to receive inputs such as, but not limited to forecasted demand for horizon 202B, insights at store level 206 and insights at warehouse level 208. The insights at store level 206 may comprise information such as, but not limited to SLA (service level agreement), inventory levels at store, stock-keeping unit (SKU), delivery day and/or delivery date. The insights at warehouse level 208 may comprise information such as, but not limited to employee efficiency, dispatch quantity, SLA, inventory levels at warehouse, information on number of fulltime and contractual labor and/or previous dispatch schedule. The constraints processor 210 may be configured to facilitate defining one or more constraints for generation of dispatch schedule such as, but not limited to capacity constraints, minimum outbound, demand constraints, frequency constraints, slack constraints and/or link constraints. Also, the constraint processor may be configured to convert the one or more constraints into algorithm specific formats and communicate to the ensemble module 212 during the generation of dispatch schedules. The ensemble module 212 may be configured to determine weighted score and determine the best fit algorithm to generate dispatch schedule. Based on the determined best fit algorithm, the ensemble module 212 may communicate the received inputs along with the one or more constraints to either optimizer 214 (which represents genetic algorithm and MILP) or heuristic module 216 (which represents heuristics model for solving the smaller problems and perform the What-If analysis) which are configured to communicate the result to outbound plan generator 218. The outbound plan generator 218 may be configured to generate dispatch schedule for outbound operations in a user readable format which are followed/executed by the warehouse through the execution engine 220, and generation of report for outbound planning. The detailed working of each module is described with examples in the subsequent paragraphs.

FIG. 2A is an architecture diagram illustrating the communication between stores, warehouses, and the automated dispatch scheduling system, according to one or more embodiments. The automated dispatch scheduling system 204 may be communicatively coupled to multiple stores and multiple warehouses over a computer network. As illustrated in FIG. 2A, stores such as Store-1, Store-2 up-to Store-N may be communicatively coupled to the automated dispatch scheduling system 204 over computer network 234 and warehouses such as Warehouse-1 228, Warehouse-2 230 up-to Warehouse-N 232 may be communicatively coupled to the automated dispatch scheduling system 204 over computer network 236. The stores and the warehouse may be a brick and mortar set-up wherein the client computing devices are installed which are configured to access the automated dispatch scheduling system 204 that acts as central sever which provides scheduling, planning and optimization service for warehouses and stores located at different geographical locations through cloud services. The Store-1 222 may store all the store level insights associated with the Store-1 222 in a database 222A. The Store-2 224 may store all the store level insights associated with the Store-2 224 in a database 224A. The Store-N 226 may store all the store level insights associated with the Store-N 226 in a database 226A. Similarly, the Warehouse-1 228 may store all the warehouse level insights associated with the Warehouse-1 228 in a database 228A. The Warehouse-2 230 may store all the warehouse level insights associated with the Warehouse-2 230 in a database 230A. The Warehouse-N 232 may store all the warehouse level insights associated with the Warehouse-N 232 in a database 232A. In one embodiment, the automated dispatch scheduling system 204 may access store level insights and warehouse level insights from all the stores and warehouses in the network, generate a dispatch schedule and communicate it to the stores and warehouses. the automated dispatch scheduling system 204 may save all the store level insights and warehouse level insights at a database 204A. The warehouses may receive their respective dispatch schedule 204 at the client computing device installed the warehouses from the automate dispatch scheduling system 204 through computer network 236 and the stores may receive updates at the client computing device installed at the stores from the automated dispatch scheduling system 204 through the computer network 234 based on the generated respective dispatch schedule. In other embodiments, the user at each warehouse through the client computing devices may access the automated dispatch scheduling system 204 remotely to generate the dispatch schedule. In other embodiments the computer network 234 and the computer network 236 may be a single network wherein all stores and warehouses are connected to automated dispatch scheduling system 204 over a common computer network.

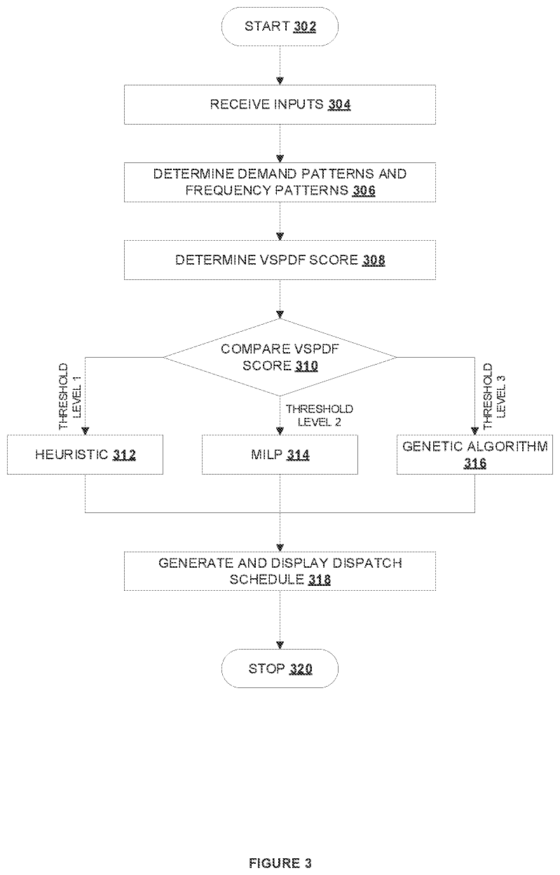

FIG. 3 is a flowchart illustrating sequence of steps of computer implemented method executed by the automated dispatch scheduling system for warehouse outbound operations, according to one or more embodiments. The method begins (302) with receiving input data by the automated dispatch scheduling system, as in step 304. The input data may comprise information such as but not limited to, insights at store level, insights at warehouse level and forecasted demand for horizon. The insights at store level may comprise information such as, but not limited to SLA (service level agreement, inventory levels at store, stock-keeping unit (SKU), delivery day and/or delivery date. The insights at warehouse level may comprise information such as, but not limited to employee efficiency, dispatch quantity, SLA, inventory levels at warehouse, number of fulltime and contractual labor and/or dispatch schedule. The forecasted demand for horizon may comprise information on projected daily demand in terms of expected number of units of inventory for each SKU at store level for future days or duration under consideration, which are obtained from the demand forecasting solutions. The planning horizon is the amount of time an organization/warehouse will look into the future when preparing a strategic plan. Based on the received inputs, demand pattern and frequency pattern may be determined as in step 306.

Demand variability is listed consistently as one of the top challenges affecting effective supply chain management. There may be large variations in the demand, in terms of quantity and frequency, from store to store and from one planning horizon to another. As in step 306, the pattern in variations in the demand in terms of quantity and frequency is determined which helps to achieve better planning, increased service levels, and greater efficiency. The demands at the warehouse are classified based on the variation in demand quantity and demand frequency which ensures the robustness of the present technique as it covers various demand scenarios. The parameters used for demand classification may be, but not limited to Coefficient of Variation (CV) and Average Demand Interval (ADI) which are defined as follows. If the planning horizon is of N days, and dᵢ is the demand on the i^{th} day, then:

$$CV = \frac{Standard Deviation of the demand}{Average Demand} = \frac{{σ}_{d δ}}{{μ}_{di}}$$

$$ADI = \frac{Planning Horizon}{Number of Non - Zero Demands} = \frac{N}{Number of Non - Zero Demands}$$

After calculation of CV and ADI the demand may be classified as lumpy, intermittent, smooth, or erratic, based on the variability in demand timing and variability in demand quantity as determined using the above-mentioned formula.

If CV²<0.49 and ADI<1.32 then the demand type may be classified as smooth. In smooth demands, the quantities demanded from the stores are almost constant (less variation) and the demand occurs regularly.

If CV²<0.49 and ADI>1.32 then the demand type may be classified as intermittent. In intermittent demands, there will be less variation in the demanded quantities, however, the interval between demands will be very high.

If CV²>0.49 and ADI<1.32 then the demand type may be classified as erratic. In erratic demands, though the demand occurs almost regularly, there is a huge variation in the demanded quantity.

If CV²>0.49 and ADI>1.32 then the demand type may be classified as lumpy. In lumpy demands, both, the quantities demanded, and the demand intervals are uncertain due to high variability.

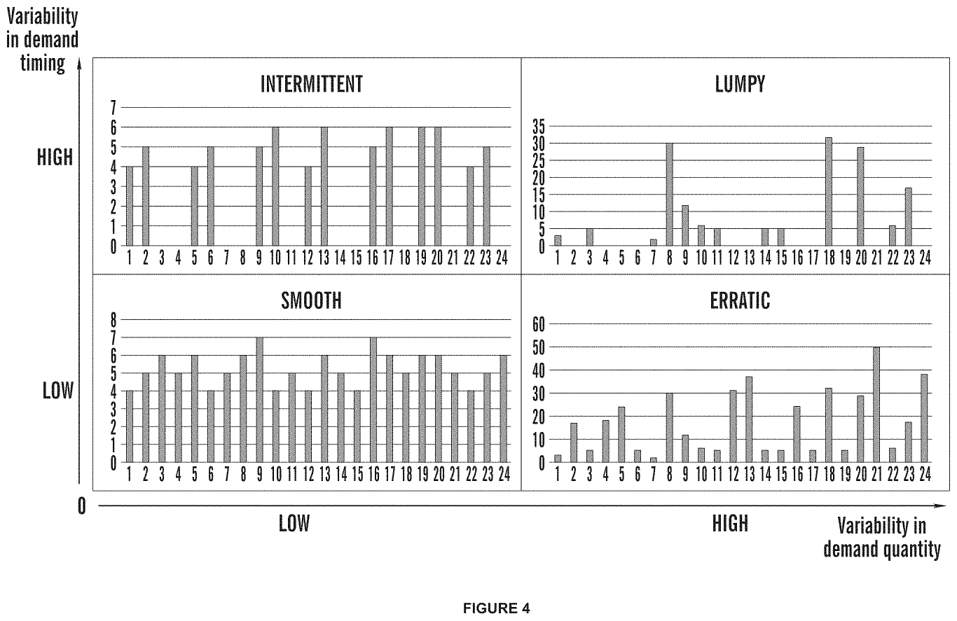

The above-mentioned classification facilitates the selection of appropriate process for optimal scheduling of deliverables/inventory to the stores from the warehouses. FIG. 4 is an exemplary graphical illustration of classification of demands based on the above-mentioned calculation, according to one or more embodiments.

Referring to FIG. 3, a weighted score may be calculated based on the input data and the determined variation pattern in the demand frequency and the demand quantities, as in step 308 through ensemble module. Unlike typical ensemble approach where all models are executed and the best model is chosen based on the result, the system of the present technique may automatically select the model based on the input data, the determined score and one or more pre-defined conditions. The weighted score (also referred as ‘VSPDF’ score) may indicate the complexity of the problem and the best approach to be employed to achieve highest efficient and optimal dispatch schedule plan. VSPDF stands for parameters such as number of variables (‘V’), number of stores (‘S’), planning horizon (‘P’), demand variation (‘D’), and frequency variation (‘F’). The VSPDF score may be used to rank the complexity of the problem.

In one or more embodiments, the parameter ‘V’ may indicate total number of variables considered in the process and may be one of the parameters to decide the complexity of the problem. The value of ‘V’ is calculated as follows:

V=(number of warehouses)*(number of stores)*(number of total patterns)*(number of distinct demand patterns)

Planning horizon ‘P’ may indicate the amount of time an organization will look into the future when preparing a strategic plan for its warehouses. For example, if a warehouse has planned to schedule shipment for 2 or 3 weeks then planning horizon will be 14 or 21 days. The demand variation ‘D’ may indicate the demand variation among the different stores for a give warehouse and frequency variation ‘F’ may indicate variation in frequency of shipment/deliveries among the different stores for a give warehouse.

In an example embodiment, consider an exemplary frequency for a store and possible patterns of deliver accepted by the store as below:

TABLE 1
Frequency and Patterns

| Frequency | 1 | 2 | 3 | 4 | 5 | 6 | 7 |
|---|---|---|---|---|---|---|---|
| Possible Patterns | 7 | 21 | 35 | 35 | 21 | 7 | 1 |
| Accepted Patterns | 5 | 13 | 21 | 17 | 7 | 5 | 1 |

The frequency may indicate number of times that a store can receive the inventory in a week. The possible patterns are determined using ⁿCᵣ formula and the accepted patterns may be such combination of patterns that suits the preference of the store. For example, if the frequency is 2, then there may be multiple combinations possible such as, delivery on Sunday and Monday, Sunday and Tuesday, Sunday and Wednesday, Monday and Tuesday, Monday and Wednesday and so on which results in 21 such combinations in a week. With a condition that the store opts for one day break between two deliveries and any other constraints, the number of accepted patterns may be less than 21. In Table 1, for frequency of 2, the accepted patterns of delivery may be 13 and this value varies from store to store based on store's preferences. If there are multiple such stores for multiple warehouses, the complexity increases. A range of values of each of ‘V’, ‘S’, ‘P’, ‘D’, and ‘F’ may be pre-defined to rank the complexity of the problem, as illustrated in Table 2. The rank may indicate the complexity of the problem. More the rank, more the complexity of the problem.

TABLE 2
Rank table for values of each parameters

| Rank → | 1 | 2 | 3 | 4 |
|---|---|---|---|---|
| Stores per warehouse | 1-20 | 21-30 | 31-40 | >41 |
| (S) | | | | |
| Frequency variation | 0-1 | 1-1.5 | 1.5-2 | >2 |
| (F) | | | | |
| Demand Variation | 0-50 | 50-100 | 100-150 | >150 |
| (D) | | | | |
| Planning Horizon in | 07-14 | 14-28 | 28-42 | >42 |
| days (P) | | | | |
| Total number of | 0-25000 | 25001-35000 | 35000-45000 | >45000 |
| variables (V) | | | | |

A condition may be predefined such that, if the VSPDF score is of threshold level 1, i.e., between 11111 and 11234, then Heuristic model may be selected by the system to determine dispatch schedule plan for the warehouse. If the VSPDF score is of threshold level 2, i.e., between 11244 and 21234, then MILP model may be selected by the system to determine the dispatch schedule plan. If the VSPDF score is of threshold value 3, i.e., more than 21234, then genetic algorithm may be selected by the system to determine dispatch schedule plan, which are described in detail in subsequent paragraphs. The VSPDF score range may be defined based on the computation time taken by each model.

In the current example embodiment, consider the values as mentioned in Table 3 and the determined VSPDF score.

TABLE 3
Exemplary values for parameters and the VSPDF scores

| Scenario | Number | Stores per | Planning | Demand | Frequency | VSPDF |
|---|---|---|---|---|---|---|
| No | Variable | DC | Horizon | Variation | Variation | Score |
| 1 | 4500 | 30 | 28 | 200 | 1.32 | 11223 |
| 2 | 7000 | 45 | 14 | 150 | 2.5 | 22111 |
| 3 | 1500 | 20 | 42 | 300 | 0.5 | 11431 |
| 4 | 11000 | 30 | 14 | 100 | 1.3 | 32212 |
| . . . | . . . | . . . | . . . | . . . | . . . | . . . |
| . . . | . . . | . . . | . . . | . . . | . . . | . . . |

As illustrated in Table 3, based on the rank assigned using range of values present in Table 2, a score of 11223 would mean that in terms of the number of variables (V), the problem of Scenario No. 1 has a rank of 1. In terms of the number of stores (S) present in the supply chain network, the rank for the Scenario No. 1 may be 2. In terms of the planning horizon (P) and the calculated demand variation (D), the Scenario No. 1 may be ranked 2 and in terms of frequency variation (F) the Scenario No. 1 may be ranked 3. The VSPDF score may be determined by concatenating the ranks of each parameter i.e. ‘V’, ‘S’, ‘P’, ‘D’, ‘F’.

In another example embodiment, consider a warehouse (for example Warehouse-1) which caters the demand of 4 stores and the planning horizon is 7 days (1 week). The demand and frequency for each store may be as illustrated in table below:

TABLE 4
Exemplary demand and frequency pattern

| | Possible | | | | | | | | | Demand |
|---|---|---|---|---|---|---|---|---|---|---|
| Frequency | Pattern | Days → | 1 | 2 | 3 | 4 | 5 | 6 | 7 | Pattern |
| 4 | 17 | Store1 | 30 | 40 | 50 | 50 | 37 | 30 | 44 | Smooth |
| 6 | 5 | Store2 | 2 | 30 | 40 | 0 | 80 | 20 | 21 | Lumpy |
| 1 | 5 | Store3 | 45 | 34 | 100 | 120 | 120 | 0 | 10 | Erratic |
| 6 | 5 | Store4 | 200 | 210 | 30 | 30 | 35 | 120 | 150 | Lumpy |
| Total | 2,125 | Total | 277 | 314 | 220 | 200 | 272 | 170 | 225 | — |
| Combination | | Demand | | | | | | | | |

According to values mentioned in Table 4, it can be said that the Store-1 needs delivery of inventory from the Warehouse-1 on 4 days in a week and Store-2 needs delivery on 6 days in a week and so on. Since the frequency is different for each store, we can say that the frequency variation which is 2.04 (using Standard Deviation). Similarly, demand variation may also be determined using the demanded quantities. In this case, it is 46.28 (Standard Deviation). The number of variables plays a critical role in defining the complexity of the problem. For the above problem, the number of variables may be calculated as:

$$No . of Variables = ( no . of warehouse ) * ( no . of stores ) * ( no . of total patterns ) * ( no of distinct demand pattern ) = 1 * 4 * 2125 * 3 = 25500$$

Thus, the resulting VSPDF score is obtained as follows:

TABLE 4
Exemplary VSPDF score.

| | Value | Rank |
|---|---|---|
| V = No. of variables | 25500 | 2 |
| S = No. of stores | 4 | 1 |
| P = Planning horizon | 7 | 1 |
| D = Demand Variation | 46.28 | 1 |
| F = Frequency Variation | 2.04 | 4 |
| VSPDF Score | | 21114 |

Referring to FIG. 3, as per the check in step 308, if the determined VSPDF score is within the threshold level 1 then the system may generate and display dispatch schedule as in step 318 using heuristic model 312; if the determined VSPDF score is within the threshold level 2 then the system may generate and display dispatch schedule as in step 318 using custom MILP model 314; and if the determined VSPDF score is within the threshold level 3 then the system may generate and display dispatch schedule as in step 318 using custom genetic algorithm 316.

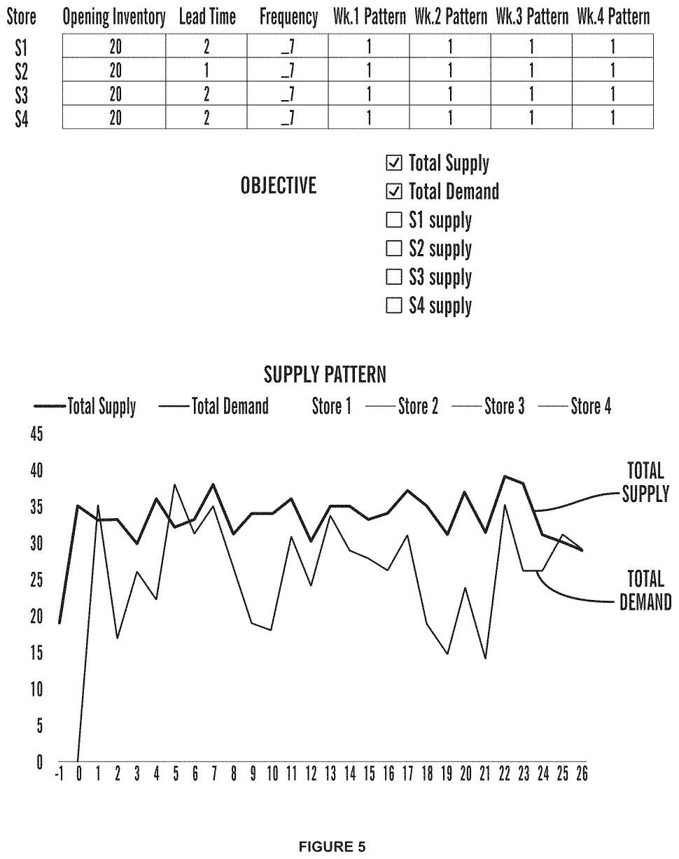

In one or more embodiments, if the determined VSPDF score is within the threshold level 1 then the system may generate and display dispatch schedule as in step 318 using heuristic model 312. The heuristic model is an approach for problem-solving, and through heuristic model the system may be configured to receive input from user wherein the system may allow user to modify input parameters such as but not limited to, opening inventory at the store, lead time, frequency, weekly patterns, total supply and/or total demand. The weekly pattern may represent the delivery pattern to the store in a particular week. For Example, if Store-1 can receive two deliveries in a week, the pattern ‘1010000’ represents that deliveries are accepted by the store on Sunday and Tuesday (can also be termed as ‘order flag’ wherein each digit representing the day of a week in sequence, ‘1’ representing ‘delivery accepted/required’ and ‘0’ representing ‘deliver not required’). The total supply may indicate sum of dispatch quantity from the warehouse (as warehouse is supplier here) to all stores across the entire horizon. The total demand may indicate the sum of demand of all the stores multiplied with the store SLA. The system may be configured to display the determined delivery/supply pattern for each store under consideration using the heuristic model 312 based on the input parameters. FIG. 5 illustrates an user interface of the automated dispatch scheduling system in case of threshold level 1, using heuristic model 312, to receive inputs from the user on various parameters either at the client computing device at the warehouse or a computing device the central automated dispatch scheduling system and the graphical representation of supply pattern may be determined using the heuristic model 312. From FIG. 5, it can be observed that the user can change the input parameters of the optimization problem such as lead time, frequency, and delivery pattern pertaining to each week. The output gives the cost of getting accounted to the warehouse due to the variation in the warehouse outbound.

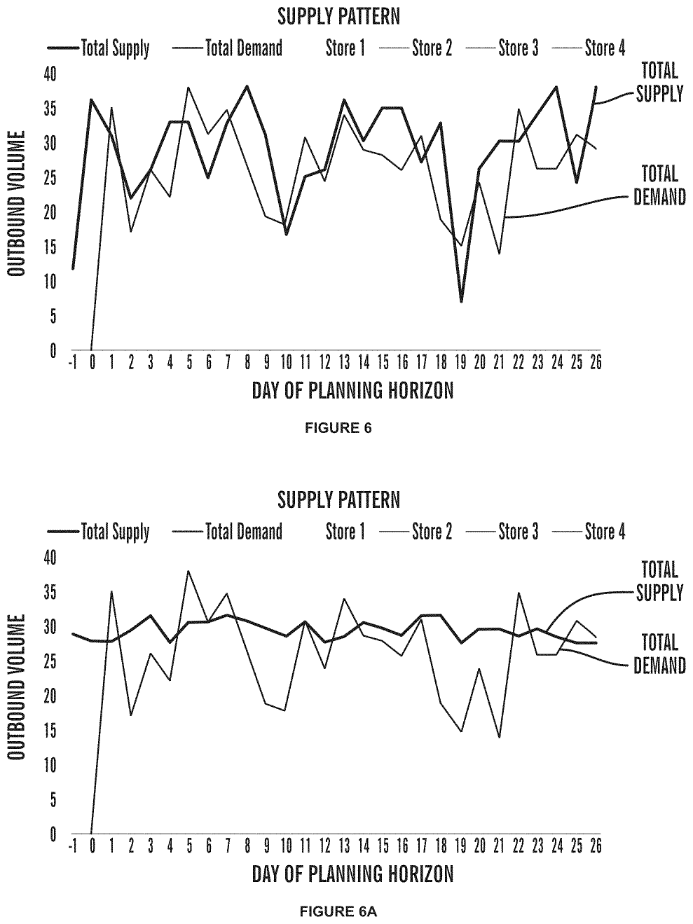

The system may allow user to change the parameters after observing the trends from the warehouse output graph. The user can perform what-if analysis by varying the input parameters as illustrated in FIG. 6 and FIG. 6A, wherein FIG. 6 illustrates the graphical representation of dispatch schedule plan or supply pattern before optimization and FIG. 6A illustrates the graphical representation of dispatch schedule plan or supply pattern after optimization by the system based on values of input parameters provided by the user. The heuristic model 312 may be selected by the system when the number of variables is less, the supply chain network is small and simple, the store or a group of stores want a specific pattern of delivery, and/or if the run time required to get the output is “immediate”. As the VSPDF score for such situation will be of threshold level 1, the system executes the heuristic model automatically to generate dispatch schedule plan for warehouse outbound operations. Further, the output generated by the system may be implemented by the warehouse.

In one or more embodiments, if the determined VSPDF score is within the threshold level 2 then the system may generate and display dispatch schedule as in step 318 using MILP model 312. The Mixed-Integer Linear Programming (MILP) model is a programming model which contain one objective function either to maximize or minimize output which in the present case is to minimize variation in warehouse throughput across the days of the planning horizon for the given one or more decision variables which are subjected to certain constraints or bounds. The decision variables are subjected to constraints to get optimized output. To determine/generate dispatch schedule plan, some of the notations to be considered as follows:

Input data such as:
Dc—represents list of all the warehouses;
Stare—represents list of all the stores;
Planning_Horizon—represents the amount of time a warehouse will look into the future when preparing a strategic plan;
Day—a specific day of the Planning_Horizon;
Demand_DayWise—represents all the demands from all the stores to the warehouse on each Day of the Planning_Horizon;
Demand_Total—represents set of total demand from each store at the end of the Planning_Horizon;
Opening_Inventory—represent set of opening stock in each store;
Min_throughput—represents minimum quantity of inventory that need to be dispatch from warehouse to keep warehouse operational (no profit no loss stage). It also represents minimum workforce needed to work so that the operational cost can be met;
Capacity—represents maximum throughput from warehouse to stores;
Lead_Time—represents time taken to deliver inventory from the warehouse to each store;
Frequency—represents set of replenishment frequencies per week to each store from the warehouse;
SLA—represents commitment on set of service levels between warehouse and store indicating list of inventory and the quantity to be delivered as per the mutual agreements for each store;
Cost—represents set of all costs incurred like labor wage, hiring, and firing cost;
Cumilative_Supply—represents set of cumulative supplies i.e., Aggregation of supply from each of the stores across the horizon period from the warehouse to each store inclusive of the Opening_Inventory; and
Cumulative_Demand—represents set of cumulative demands i.e., Aggregation of daily demand of each of the stores in the horizon period, from each of the stores.

Some of the decision variables, which represents the key deciding factors for generation of the output, may be:
Quantity[w,s,d1,d2]—a integer variable which represent the quantities to be shipped from warehouse ‘w’ to store ‘s’ with dispatch day as ‘d1’ and delivery day as ‘d2’ such that d2=d1+Lead_Time[w][s] and ‘d2’ is always lesser than the horizon with lower bound at zero; and
Order_Var[w,s,d1]—a binary variable which represent the order quantity dispatched from warehouse to store wherein ‘d1’ is the dispatch day with lower bound at zero.

Some of the slack variable, which represent the deviations from the required output (throughput/SLA of the warehouse) and may be represented as:
Sl1[w,d1] and Sl2[w,d1]—which represents the deficit Sl2 quantities and surplus Sl1 quantities delivered from the warehouse to check the variation in comparison to the previous day delivery; and
Sl3[w,d2] and Sl4[w,d2]—which represents the deficit Sl3 quantities and surplus Sl4 quantities which are affecting the given SLA of the store.

TABLE 5
Exemplary calculation of slack variable

| | | | | | | | SL3/SL4 |
|---|---|---|---|---|---|---|---|
| Day | Supply | Supply Slack | SL1/SL2 | SLA | Demand | SLA Slack | (Supply-SLA) |
| 1 | 23 | 0 | Not applicable | 32 | 40 | −9 | Deficit |
| 2 | 45 | −22 | Deficit | 32 | 40 | 13 | Surplus |
| 3 | 34 | 11 | Surplus | 32 | 40 | 2 | Surplus |
| 4 | 56 | −22 | Deficit | 32 | 40 | 24 | Surplus |
| 5 | 34 | 22 | Surplus | 32 | 40 | 2 | Surplus |
| 6 | 34 | 0 | Balanced | 32 | 40 | 2 | Surplus |
| 7 | 45 | −11 | Deficit | 32 | 40 | 13 | Surplus |

The supply slack values for each day may be determined using the formula:

Supply slack=supply for the Day ‘N’—Supply for the Day ‘N+1’

wherein N indicates the current day; and
N+1 indicates the next day.

Objective function Z may be represented as:

$$Z = {Z}_{1} + {Z}_{2}$$

$$wherein ,$$

$${Z}_{1} = {\sum }_{w = 1}^{n} {\sum }_{d 1 = 1}^{horizon} ( sl {1}_{[ w , d ]} + sl {2}_{[ w , d ]} )$$

$${Z}_{2} = 100 * {\sum }_{w = 1}^{n} {\sum }_{d 2 = d 1 + lead \_ time [ w ] [ s ]}^{horizon} {\sum }_{s = 1}^{n} sl {3}_{[ w , d , s ]}$$

The objective is to minimize the value of ‘Z’ which represents variation in outbound operations, which is determined as summation of two aspects Z₁ and Z₂. First aspect Z₁ indicates variation in daily output from the warehouse. For example, on day 1 the output is 11 and on day 2 the output is 12 and on day 3 the output is 10, sl1 will have the value 1 (i.e. 12−11) and sl2 will have the value 2 (i.e. 12−10). The total sum of sl1 and sl2 must be as low as possible. Second aspect Z₂ indicates variation in supply for the required demand if supply is less than demand. For example, if demand from the warehouse is 50 units, the system through the algorithm may generate dispatch schedule in such a way to allocate supply as close to 50 units as possible and at the same time not deviate much from the balanced throughput. The variable sl3 is given more importance compared to sl1 and sl2 variables as can be seen by the co-efficient of 100 provided, thereby adding more weightage in the equation.

Some of the constraints such as, but not limited to capacity constraints, minimum outbound, demand constraints, frequency constraints, slack constraints and/or link constraints may be considered based on the operation context and requirements to replicate the problem as close as possible to the real-world scenario.

The capacity constraint may indicate the fulfilment capacity of the warehouse with respect to resources like manpower, machinery, inventory available in warehouse, etc. Physically it is not possible to transfer more units of inventory from the warehouse beyond the capacity of the warehouse. Hence, it becomes an upper bound constraint. The capacity constraint may comprise:
Max_Throughput which indicates a condition that sum of quantities delivered from the warehouse on each day should not exceed the maximum throughput capacity of the warehouse. That is, for each day:

$${\sum }_{w = 1}^{n} {\sum }_{s = 1}^{n} Quantity [ w , s , d 1 , d 2 ] \leq Capacity [ d 1 ]$$

wherein d2∈d1+lead_time[w][s] and d2≤horizon.
Minimum_Outbound which indicates quantities of inventory delivered from the warehouse on each day must me more than the minimum throughput capacity of the warehouse. That is, for each day:

$${\sum }_{w = 1}^{n} {\sum }_{s = 1}^{n} quantity [ w , s , d 1 , d 2 ] \geq min\_throughput [ d 1 ]$$

wherein d2∈d1+lead_time[w][s] and d2≤horizon.

The demand constraints may be significant to drive the algorithm to transfer enough units of inventory from the warehouse to the store such that the demands of the store are satisfied. The demand constraints may comprise:
Total_Demand_Constraint which indicates the sum of quantities delivered from the warehouse to each store on each day and must be equal to the total demand. That is, for each store:

$${\sum }_{w = 1}^{n} {\sum }_{d 1 = 1}^{horizon} quantity [ w , s , d 1 , d 2 ] = demandtotal [ s ]$$

wherein, d2∈d1+lead_time[w][s] and d2≤horizon
Day wise demand constraint to reduce SLA violation may be represented as:

$${\sum }_{w = 1}^{n} {\sum }_{s = 1}^{n} {\sum }_{d 1 = 1}^{horizon} ( cumusupply - cumudemand [ s ] [ d 1 + leadtime [ w ] [ s ] ] + sl 3 [ w , s , d 1 + leadtime [ w ] [ s ] ] - sl 4 [ w , s , d 1 + leadtime [ w ] [ s ] ] ) = 0$$

The frequency constraints may indicate number of times the store can accept the inventory from the warehouse. Each store has a limit on how many days it can accept incoming inventory from the warehouse. This value is defined by the store manager. If a store has a frequency constraint of 3, then the warehouse can send inventory to the store only 3 times per week. The frequency constraint may be determined as:

$${\sum }_{w = 1}^{n} {\sum }_{d 1 = 1}^{horizon} ordervar [ w , s , d 1 ] = frequency [ s ]$$

$${\sum }_{w = 1}^{n} {\sum }_{d 1 = 1}^{7} ordervar [ w , s , d 1 ] = {\sum }_{w = 1}^{n} {\sum }_{d 1 = 8}^{horizon} ordervar [ w , s , d 1 ]$$

The slack constraint may indicate the difference in quantity transferred from the warehouse to the store on consecutive days. For each warehouse and for each day, the slack constraint may be represented as:

$$sl 2 [ w , d 1 ] - sl 1 [ w , d 1 ] = {\sum }_{s = 1}^{n} quantity [ w , s , d 1 , d 2 ] - quantity [ w , s , d 1 - 1 , d 2 - 1 ]$$

The link constraint may indicate that the transfer of inventory from the warehouse to stores can take place only if an order flag between the warehouse and the store is set to “1”. For each warehouse, for each day and for each store, the link constraint is represented as:

quantity[w,s,d1,d2]≤1000*ordervar[w,s,d1]

wherein d2∈d1+lead_time[w][s] and d2≤horizon; and

quantity[w,s,d1,d2]≥ordervar[w,s,d1]

wherein d2∈d1+lead_time[w][s] and d2≤horizon

The inputs may either be received from the user or may be accessed from the database associated with the stores and warehouses based on user actions. After receiving inputs, based on the user defined parameters, the data pertaining to the stores and warehouses for those specific dates are provided as input to the system. The data is then transformed into the algorithm specific format before the execution of optimization. After execution of model, an output is generated as in step 318 which provides a strategic dispatch schedules for each store that comprises the optimal quantities to be delivered on a given day to a store such that the warehouse outbound operation is smoothened.

In an example embodiment, consider that there is one warehouse and 30 stores need to be served by the warehouse with planning horizon of 28 days. Every store has a frequency requirement per week. (E.g. Store-1 accepts delivery just once per week, Store-2 twice per week, and so on). Consideration of demand at the store may not be required at the stock-keeping unit level. Aggregated demand converted in terms of inventory to be shipped may be considered so that there is a single demand number/quantity per store per day. The objective may be to plan the dispatch schedule for the 30 stores such that the workforce requirement of the warehouse throughout the planning horizon is smoothened i.e. the daily outbound product flow is almost the same, thereby ensuring maximum workforce utilization. The inputs may be, but not limited to, forecasted daily demand, lead times, delivery frequency, service-level agreement (SLA) and/or opening inventory. Exemplary forecasted demand is illustrated in Table 6.

TABLE 6
Forecasted daily demand for stores

| Day | S1 | S2 | S3 | S4 | S5 | S6 | . . . | S30 |
|---|---|---|---|---|---|---|---|---|
| Day 1 | 64 | 18 | 25 | 19 | 59 | 15 | . . . | 35 |
| Day 2 | 0 | 67 | 31 | 15 | 83 | 19 | . . . | 30 |
| Day 3 | 69 | 21 | 76 | 57 | 92 | 35 | . . . | 12 |
| Day 4 | 74 | 10 | 23 | 48 | 0 | 7 | . . . | 25 |
| . . . | . . . | . . . | . . . | . . . | . . . | . . . | . . . | . . . |
| Day 28 | 53 | 43 | 32 | 27 | 15 | 42 | . . . | 36 |

The lead times may be the time taken to deliver inventory from the warehouse to each store. The delivery frequency may be number of days a store desires to receive deliveries. For example, Store-1 may accept deliveries once it a week, Store-2 may need the delivery twice a week and so on. SLA may represent the service expectation by each store. For example, Store-1 may expect delivery form the warehouse such that 95% of its demand is met. Opening inventory may be inventory level at each store at the start of the planning horizon. These inputs are illustrated in Table 7.

TABLE 7
Input parameters for MILP

| | Opening | | Lead | |
|---|---|---|---|---|
| Store | inventory | Frequency | Times | SLA |
| S1 | 50 | 1 | 4 | 0.95 |
| S2 | 50 | 2 | 3 | 0.95 |
| S3 | 50 | 3 | 2 | 0.95 |
| S4 | 50 | 4 | 1 | 0.95 |
| S30 | 50 | 2 | 3 | 0.95 |

The inputs may either be received from the user at the warehouse or may be accessed from the database of the warehouses based on user actions. Being an optimization problem, MILP is used to approach the problem, given that the objective function and all the constraints used can be expressed in a linear manner and follows linearity.

After receiving inputs, the system may process the inputs by considering one or more parameters and one or more constraints. The one or more parameters may be the ‘order variable’ and ‘quantity variable’. The order variable may be represented as Order_Var[w,s,d1] which is a binary variable, wherein if the value is ‘1’ it indicates that that dispatch to be made from the warehouse to the store ‘s’ on the day ‘d1’ and if the value is ‘0’ it indicates that no inventory to be dispatched. The quantity variable may be represented as Quantity[w,s,d1,d2] which is an integer variable which indicates the quantity of inventory to be dispatched from the warehouse to the store ‘s’ on the day ‘d1’ and to be received by the store on the day ‘d2’. The one or more constraints may be, but not limited to—‘number of store deliveries’ which indicates the number of deliveries to the store that cannot exceed the value specified by the user; ‘demand constraint’ which indicates the need to meet the daily demand specified by meeting SLA for each store; ‘inventory linking constraint’ which refers to linking of inventory values in warehouse and stores based on incoming and outgoing quantities for each day—for example,

store inventory for the next day=today's inventory at store+incoming supply−demand

‘order variable constraint’ and ‘quantity variable constraint’ which indicates that the quantity variable can take a value only if the corresponding order variable is present i.e., there cannot be a situation where there is a quantity delivered to the store although there is no dispatch scheduled to the store or vice versa; and ‘constraint of maximum throughput’ which indicates that the total quantity dispatched from the warehouse should be ≤1.1 times (for example) the maximum throughput from the warehouse. E.g. if maximum throughput from Warehouse-1 is 1000 (subject to availability of workforce) maximum quantity dispatched on any given day from warehouse−1 should be ≤1.1*1000=1100 (assuming that the excess can be achieved by overtime). Mathematically, in this example,

$${\sum }_{s = 1}^{30} Qn ( 1 , s , d 1 , d 2 ) \leq 1100 \qquad ∀ d 1 , d 2$$

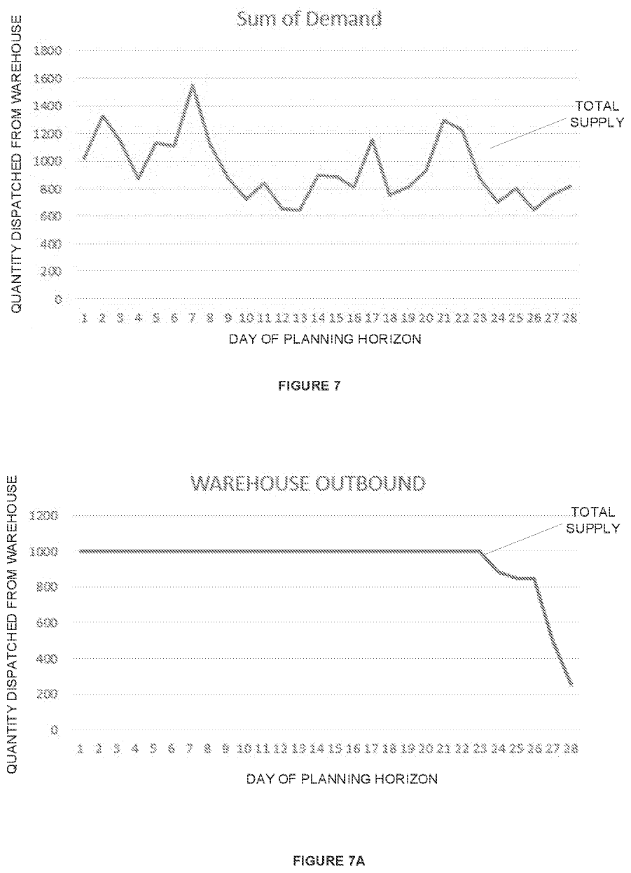

The optimization problem may be automated using mathematical optimization solver (preferably commercial solver like Gurobi by way of example). After execution of model, an output is generated which provides a strategic dispatch schedules for each store that comprises the optimal quantity to be delivered on a given day to a store such that the warehouse outbound operation is smoothened. The output comprises daily dispatch plan from warehouse, daily warehouse throughput and labor utilization which are displayed at the client computing device either in a tabular format or graphical format using a graphical processing unit associated with the client computing device. The daily dispatch plan may comprise stores as rows and days as columns. The numbers at the intersecting cells may represent the quantities to be dispatched for the corresponding store on the corresponding day. E.g. A quantity of 26 is to be dispatched for Store-6 on Day 1. The daily warehouse throughput represents the total outbound inventory that need to be shipped out from the warehouse. The graph titled ‘Sum of demand’ as illustrated in FIG. 7 depicts the daily aggregated demand from the stores which is before the optimization and generation of dispatch schedule plan by the system. The graph “Warehouse Outbound” as illustrated in FIG. 7A depicts the total quantity dispatched from the warehouse each day in the planning horizon which is smooth as desired based on the execution of custom MILP model by the automated dispatch scheduling system. The labor requirement/utilization may can also be programmed to act as a minimum-maximum constraint while generating the outbound and allows a ranged percentage of variation. This will help the warehouses in optimal labor allocation.

Referring to FIG. 3, in one or more embodiments, if the determined VSPDF score is of threshold level 3 then the system may automatically generate and display dispatch schedule as in step 318 using the genetic algorithm 316. The genetic algorithm is a search heuristic algorithm that is inspired by Charles Darwin's theory of natural evolution and reflects the process of natural selection where the fittest individuals are selected for reproduction to produce offspring of the next generation. The genetic algorithm implementation follows a responsibility driven approach which means that each part of the genetic algorithm is isolated into individual classes making it possible to put together an optimizer satisfying the needs of a specific optimization problem. The most important part of the genetic algorithm is to define the evaluation function and population. The genetic algorithm may be configured to generate delivery schedules for the warehouse to cater requirement of stores, to ensure that the demands at the store are met by the given delivery schedule and to ensure that there is less variation in the daily warehouse outbound operations to minimize the variation (excess/less) in outbound operations.

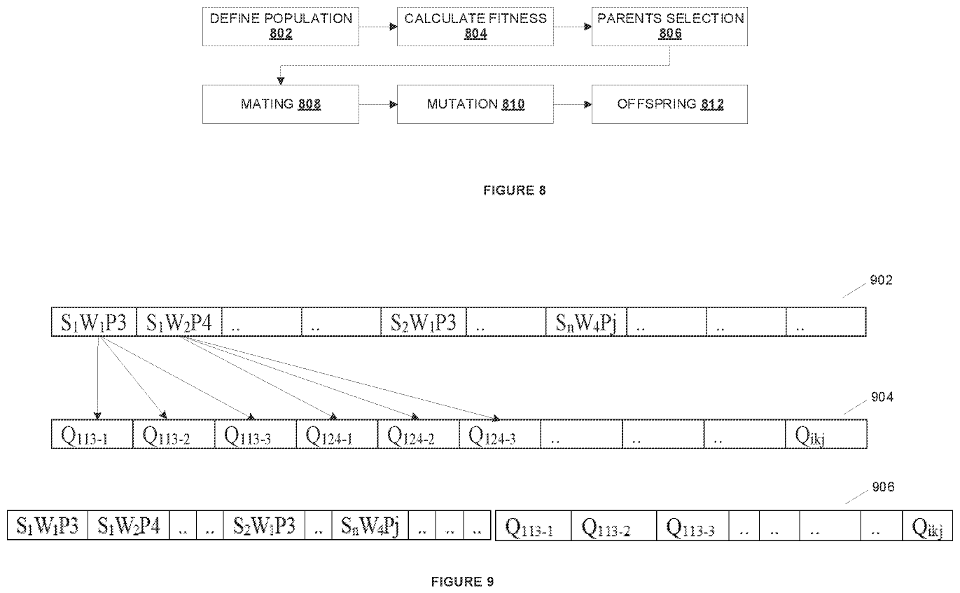

FIG. 8 is a process flow diagram illustrating sequence of steps executed by the optimizer (automated dispatch scheduling system) to generate dispatch schedule plan using custom genetic algorithm, according to one or more embodiments. In one or more embodiments, a population may be defined as in step 802. A population is a group of individuals wherein every individual is represented by a chromosome, and each chromosome comprises genes which are nothing but the variables for the given set of optimization problem. It is to be noted that the significant part of genetic algorithm lies in designing the chromosome, developing a fitness function, and determining the set of delivery patterns to avoid suboptimal/infeasible solution. A chromosome may comprise two parts that depend on the task that the chromosome needs to perform. The outcome of the custom genetic algorithm is to determine when to dispatch inventory/goods to the store and how much amount of inventory/goods to be included in each dispatch. To achieve the outcome, the chromosome may be designed by the optimizer/system as, for each week—the first part of the chromosome comprises gene which may represent the pattern number for the store for a week; and the second part may comprise the amount of inventory that need to be delivered from the warehouse to that store in a week according to the selected pattern. For example, if there are ‘x’ stores, the for a week, the first ‘x’ genes may represent the patterns assigned to each store. Consider that Store-1 has delivery frequency 3, and a pattern Monday-Wednesday-Friday is selected for the store. Thus, for Store-1, amount of inventory to be included in all three delivery needs to be determined. This will result in addition of 3 genes to the chromosome representing the quantity to be delivered to the Store-1 in 3 days. So, if there are x stores and each has a delivery frequency of 2 then for 1 week the length of the chromosome will be x+2*x. Similarly, the chromosome will be built for the remaining weeks. The length of the chromosome will be proportional to number of stores, number of weeks and delivery frequency for each store.

In an example embodiment, if Store-1 is opting for 3 deliveries in a week, then the possible delivery frequency combinations may be ⁷C₃, i.e., 35 as illustrated in Table 8.

TABLE 8
Exemplary delivery frequency combinations for Store-1

| Days | Sun | Mon | Tue | Wed | Thu | Fri | Sat |
|---|---|---|---|---|---|---|---|
| Pattern 1 | 1 | 0 | 1 | 0 | 1 | 0 | 0 |
| Pattern 2 | 0 | 1 | 0 | 1 | 1 | 0 | 0 |
| Pattern 3 | 1 | 0 | 0 | 1 | 0 | 0 | 1 |
| . | . | . | . | . | . | . | . |
| . | . | . | . | . | . | . | . |
| . | . | . | . | . | . | . | . |
| Pattern 35 | 0 | 1 | 0 | 0 | 1 | 1 | 0 |

As illustrated in Table 8, there may be 35 possible combinations of delivery frequency but combinations where deliveries are scheduled on consecutive days are poor options and are not recommended. To avoid such a situation, a subset of combinations from the overall set of all possible combinations may be considered for calculation. These are called eligible delivery combinations.

Some of the parameters to be considered for generating schedule plan using custom genetic algorithm are, but not limited to, stores represented as ‘Sᵢ’ wherein i⊆number of stores, week represented as ‘Wₖ’ wherein k⊆number of weeks in planning horizon, pattern represented as ‘Pⱼ’ wherein j⊆frequency of delivery to stores and quantity represented as ‘Qᵢₖⱼ’ wherein ‘Q’ represents the quantities to be delivered from the warehouse to the stores.

Based on the number of stores, number of weeks in the planning horizon and the delivery frequency pattern the first part of the chromosome may be generated and second part of the chromosome may be generated based on the inventory to be delivered for each of the combination of number of stores, number of weeks in the planning horizon and the delivery frequency pattern. FIG. 9 illustrates the generated exemplary chromosomes wherein 902 indicates the first part of the chromosome and 904 indicates the second part of the chromosome. A final chromosome 906 may be generated and multiple such chromosome may be created which forms the population for the given problem, as in step 802.

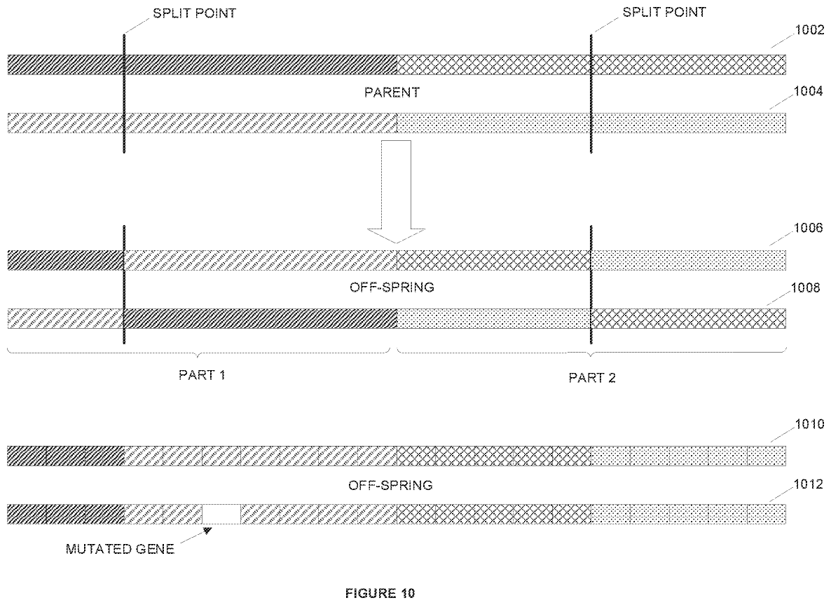

Referring to FIG. 8, a fitness of the chromosomes may be determined by calculating fitness score by defining an evaluation function, as in step 804. Each of the generated chromosomes are evaluated/assessed for their performances using fitness value/scores. The higher the fitness score, better the solution. This scoring may be performed by—determining the variance of the quantities delivered to the store which are present in the second part of the chromosomes; by identifying whether there a stock out or lost demand for the determined set of possible deliveries at each store; and by determining the inventory level maintained at the store. The variance of the quantities delivered may be determined by calculating sum of squares of the difference in units transferred daily and the mean and the whole expression being divided by the total number of days. If there is stock out or lost demand, the penalty value may be considered while determining the score which is proportional to the square of the stock out quantities. The concept of ‘penalty’ is to make the algorithm give importance to the lost sales and try to send more units from warehouse to the stores without merely looking at balancing the throughput from the warehouse. Also, penalty values may be considered while scoring when the inventory level maintained at the store is too high or too low which may be defined based on safety stock (SS) levels. For example, if SS becomes less than half of actual capacity it is considered as too low and if SS is double the demand it is considered as too high. The fitness score of a chromosome is inverse of weighted sum of the above-mentioned factors. Thus, the chromosome with highest score may be considered as best fit (best solution) in the population generated. However, there may be another chromosome which may be better than the best fit obtained. To determine the best chromosome, mating pools may be identified comprising pair of chromosomes called as parents selected from the population, as in step 806. The parent population is chosen based on fitness score of chromosomes such that a high-quality chromosome has a higher probability of being selected in the pool (fitness-proportionate selection). After selecting the parent population, cross-over/mating may be performed to generate offspring, as in step 808. Each set of parents in the mating pool may produce two offspring i.e. two other chromosomes. Thus, if there are 100 individuals (chromosomes) in the population, the mating pool will have 50 sets of parents chosen probabilistically which will produce 2 offspring each. Therefore, we will now have 100 offspring forming the children population. The offspring may be generated using a random point crossover. FIG. 10 illustrates representation of parent chromosomes 1002 and 1004 wherein that part 1 and part 2 are shaded different in each of the chromosomes 1002 and 1004 for representation purpose. The split points are selected randomly, and the mating/cross-over is performed which results in offspring chromosomes 1010 and 1012. It should be observed that each part of the chromosome is treated as an independent chromosome. One point is chosen at random in each of the two parts of the chromosome and the genes are then exchanged as depicted in 1006 and 1008 to generate the offspring chromosomes. After crossing over of all the parents, the resultant may be an initial population and a children population, both of equal size.

While mating/cross-over enhances the exploitation of the best solution and converges the algorithm towards a solution, the mutation 810 is a divergence operation that enables exploration by increasing the diversity and provides a mechanism for escaping from a local optimum. The mutation rate is the number of genes in each chromosome of the children population to be mutated. Let us suppose the mutation rate is 5%, then 5% of randomly selected genes in every chromosome of the children chromosome will be replaced by a random value that it can take. This may result in 100 mutated offspring as in step 812 constituting the mutated population.

There are three population—parent population (initial population), the children population, and the mutated population of equal size. To get the next generation, fitness score may be calculated for all the new chromosomes generated. The next generation may be obtained by retaining the chromosomes with highest scores among all. The new generation may be then be treated as initial population and the steps 802, 806, 808, 810, and 812 may be repeated for many generations, in some cases for pre-defined number of iterations. The best solution to the optimization problem may be that chromosome with the highest score in the last generation, which maybe the dispatch schedule plan for warehouse outbound operations.

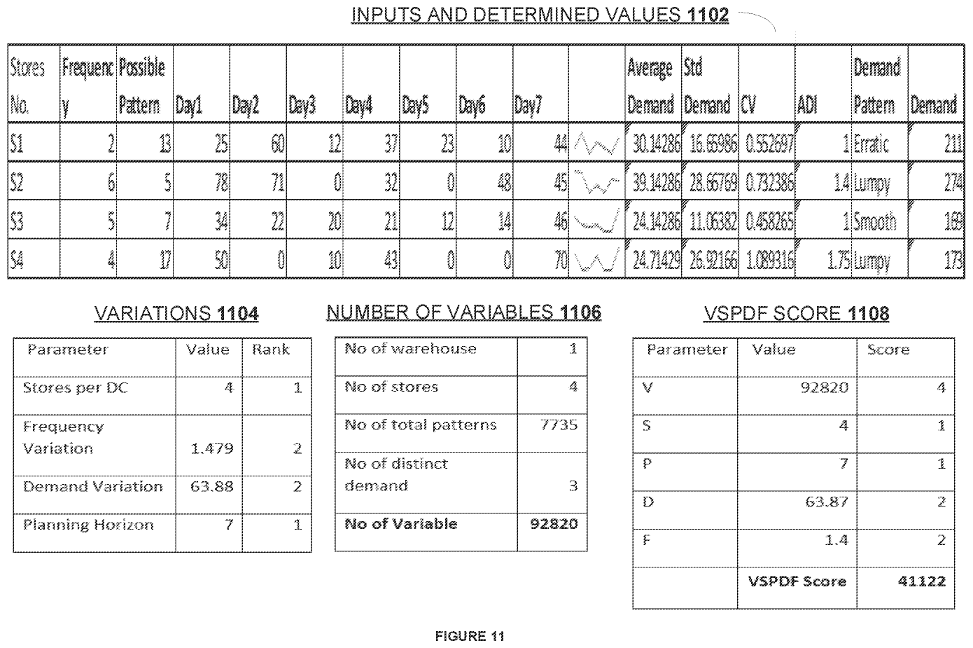

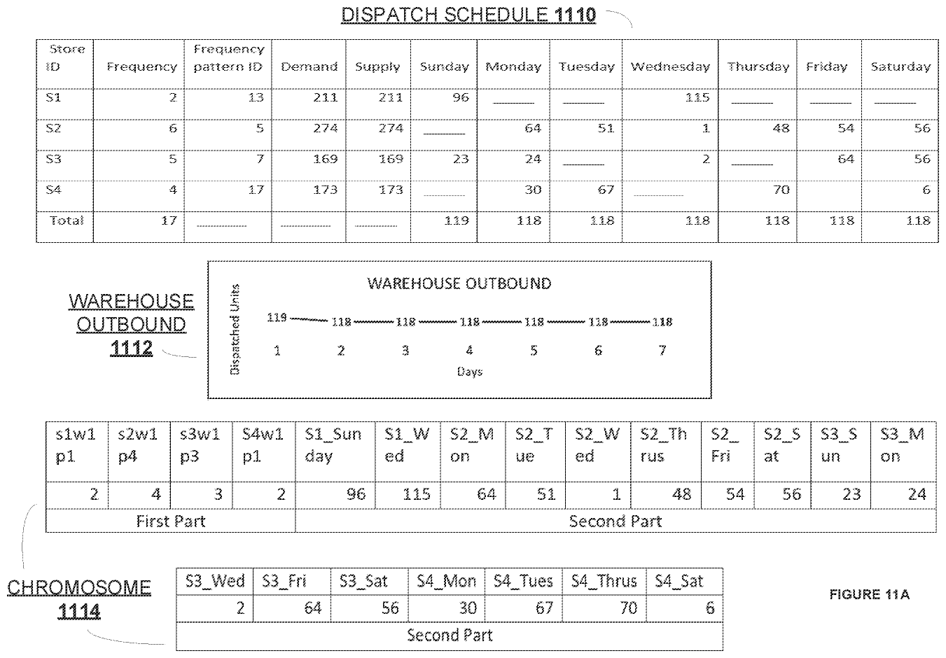

In an example embodiment, consider that there is one warehouse and 4 stores with 7 days as a planning horizon. As per the process as described in various embodiments of the present disclosure, store details, frequency, daily demand of each of the stores may be received as input, and possible pattern, average demand, CV, ADZ, demand pattern may be determined. FIG. 11 illustrates the received inputs and the determined values 1102. The frequency variation and demand variation may be determined as described in previous paragraphs which is illustrated in 1104, value of number of variables may be calculated as illustrated in 1106 and VSPDF score 1108 may be determined as described in various embodiments of the present disclosure. As the VSPDF score is of threshold level 3, the system may select custom genetic algorithm to generate dispatch schedule 1110 which is illustrated in FIG. 11A. The warehouse outbound information 1112 may indicate the quantity of inventory to be shipped from the warehouse to all stores in total for each day in a week based on the generated dispatch schedule 1110. The chromosome 1114 may indicate the output generated by the system by the method of custom genetic algorithm as described in previous paragraphs, which may be communicated to the warehouses from the automated dispatch scheduling system.

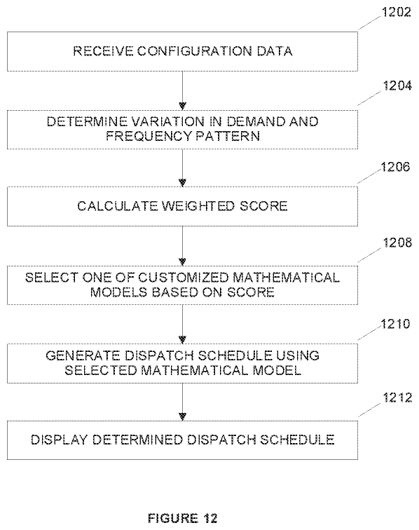

FIG. 12 is a process flow diagram illustrating method executed by the automated dispatch scheduling system, according to one or more embodiments. In one or more embodiments the method comprises receiving configuration data from a user, as in step 1202. The user may provide configuration data as input to the automated dispatch scheduling system from the warehouse through a computer network. In another embodiment, the user may provide inputs at the automated dispatch scheduling system centrally, having access to all the warehouses and stores in the network. Alternatively, based on the instruction from the user either from the warehouse or the instructions from the user interface at the automated dispatch scheduling system, the automated dispatch scheduling system may access the configuration data from the database associated with the stores and warehouses and may store in its database for further processing as described in various embodiments of the present disclosure.

In one or more embodiments, the configuration data may comprise information about a warehouse (termed as ‘warehouse level insights’) and one or more stores (termed as ‘store level insights’) such as, but not limited to count of stores, count of warehouses, warehouse-store mapping and forecasted demand for each of the stores for the horizon. The warehouse-store mapping may indicate which warehouse needs to cater the demand of which store. Some stores may have preference for certain warehouses considering the logistic feasibility and distance parameters and warehouse-store mapping indicates such preferences. A variation in demand pattern and variation in frequency pattern of the one or more stores is determined, as in step 1204 and a weighted score (termed as VSPDF score) is calculated based on the determined variation in demand pattern and frequency pattern, as in step 1206. The determination of variation in demand pattern and variation in frequency patters is described in previous paragraphs in relation to FIG. 4. The determination of VSPDF score is described various embodiments and also in relation to FIG. 3 and FIG. 4. At least one of plurality of customized models is selected dynamically based on the calculated weighted score, as in step 1208. The plurality of customized models comprises genetic model, heuristic model, and/or Mixed Linear Programming (MILP) model. A dispatch schedule for the warehouse may be determined by executing the selected at least one customized model as in step 1210 and the determined dispatch schedule is displayed graphically at a computing device of the user, as in step 1212. The steps of determining the dispatch schedule through heuristic model and MILP is described in detail in various embodiments of the present disclosure.

In one or more embodiments, when the selected at least one model is the genetic model, the step of determining dispatch schedule comprises, composing one or more chromosomes for plurality of combination of delivery pattern and quantity of items to be delivered from the warehouse to the store, identifying a best fit chromosome from one or more chromosomes by generating offspring of the one or more chromosomes and eliminating mutated chromosomes from the one or more chromosomes. The delivery pattern for one or more chromosomes is at least one of plurality of combinations of a store, a warehouse and frequency of delivery of items to each store. The delivery pattern and the quantity of items of the best fit chromosome are displayed as a dispatch schedule to the user as described in various embodiments of the present disclosure in relation to FIG. 8, FIG. 9, FIG. 10, FIG. 11 and FIG. 11A.

In one or more embodiments, a non-transitory computer readable medium having stored thereon instructions for automated generation of dispatch schedule is disclosed, the non-transitory computer readable medium comprising machine executable code which when executed by at least one processor, causes the at least one processor to perform steps comprising, receiving a configuration data from a user, the configuration data may comprise information about a warehouse and one or more stores such as count of number of stores, count of number of warehouses, a warehouse-store mapping information and a forecasted demand for each of the one or more stores for a horizon. Variations in demand pattern and variations in frequency pattern of the one or more stores may be determined and a weighted score may be calculated based on the determined variations. At least one of plurality of customized models may be selected dynamically based on the calculated weighted score. The plurality of customized models comprises a genetic model, a heuristic model, and a mixed linear programming model. A dispatch schedule for the warehouse may be generated by executing the selected at least one of the plurality of customized models and the determined dispatch schedule may be displayed graphically at a computing device of the user.

When the selected at least one of plurality of customized models is the genetic model, the step of generating dispatch schedule may comprise, composing one or more chromosomes for plurality of combination of a delivery pattern and a quantity of inventory to be delivered from the warehouse to the one or more stores, identifying a best fit chromosome from the one or more chromosomes by generating one or more offspring of the one or more chromosomes and eliminating one or more mutated chromosomes from the one or more chromosomes. The delivery pattern for one or more chromosomes may be at least one of plurality of combinations comprising at least one store, at least one warehouse and a frequency of delivery of inventory to one or more stores. The delivery pattern and the quantity of items of the best fit chromosome may be displayed as a dispatch schedule at the computing device to the user.

The technology described in the present disclosure demonstrates faster processing and report generation without trial and error. optimal solution is always arrived at for smaller as well as larger supply chain comprising warehouses and stores. A user can trade-off run time and optimality by changing required parameters thereby leading to overall flexibility in incorporation.

The specification and drawings in the present disclosure are to be regarded in an illustrative rather than a restrictive sense.

What is claimed is:

1. A computer implemented method for an automated generation of dispatch schedule, the method comprising:
receiving, at a processor, a configuration data from a user comprising information about a warehouse and one or more stores;
determining, at the processor, variations in demand pattern and variations in frequency pattern of the one or more stores;
calculating, at a processor, a weighted score based on the determined variations;
dynamically selecting, at the processor, at least one of plurality of customized models based on the calculated weighted score;
generating, at the processor, a dispatch schedule for the warehouse by the selected at least one of the plurality of customized models; and
graphically displaying, by the processor, the determined dispatch schedule at a computing device of the user.

2. The method of claim 1, wherein the plurality of customized models comprises a genetic model, a heuristic model, and a mixed linear programming model.

3. The method of claim 1, wherein the selected at least one of the plurality of customized models is the genetic model, wherein the determining the dispatch schedule for the warehouse, comprising:
composing, at the processor, one or more chromosomes for plurality of combination of a delivery pattern and a quantity of inventory to be delivered from the warehouse to the one or more stores;
identifying, at the processor, a best fit chromosome from the one or more chromosomes by:
generating, at the processor, one or more offspring of the one or more chromosomes; and
eliminating, at the processor, one or more mutated chromosomes from the one or more chromosomes; and
displaying, by the processor, the delivery pattern and the quantity of inventory of the best fit chromosome as a dispatch schedule to the user.

4. The method of claim 3, wherein the delivery pattern for the one or more chromosomes is at least one of plurality of combinations comprising, at least one store, at least one warehouse and a frequency of delivery of inventory.

5. The method of claim 1, wherein the configuration data comprises a count of number of stores, a count of number of warehouses, a warehouse-store mapping information and a forecasted demand for each of the one or more stores for a horizon.

6. An automated dispatch scheduling system, comprising:
at least one processor; and
at least one memory unit operatively coupled to the at least one processor, having instructions stored thereon that, when executed by the at least one processor, causes the at least one processor to:
receive, a configuration data from a user comprising information about a warehouse and one or more stores;
determine, variations in demand pattern and variations in frequency pattern of the one or more stores;
calculate, a weighted score based on the determined variations;
dynamically select, at least one of plurality of customized models based on the calculated weighted score;
generate, a dispatch schedule for the warehouse by executing the selected at least one of the plurality of customized models; and
graphically display, the determined dispatch schedule graphically at a computing device of the user.

7. The system of claim 6, wherein the plurality of customized models comprises a genetic model, a heuristic model, and a mixed linear programming model.

8. The system of claim 6, wherein the selected at least one of plurality of customized models is the genetic model, wherein the determining the dispatch schedule for the warehouse, comprising:
compose, one or more chromosomes for plurality of combination of a delivery pattern and a quantity of inventory to be delivered from the warehouse to the one or more stores;
identify, a best fit chromosome from the one or more chromosomes by executing one or more instructions causing the at least one processor to:
generate, one or more offspring of the one or more chromosomes; and
eliminate, one or more mutated chromosomes from one or more chromosomes; and
graphically display, the delivery pattern and the quantity of inventory of the best fit chromosome as a dispatch schedule to the user.

9. The system of claim 8, wherein the delivery pattern for the one or more chromosomes is at least one of plurality of combinations comprising at least one store, at least one warehouse and a frequency of delivery of inventory.

10. The system of claim 6, wherein the configuration data comprises a count of number stores, a count of number of warehouses, a warehouse-store mapping information and a forecasted demand for each of the one or more stores for a horizon.

11. A non-transitory computer readable medium having stored thereon instructions for automated generation of dispatch schedule, the non-transitory computer readable medium comprising machine executable code which when executed by at least one processor, causes the at least one processor to perform steps comprising:
receiving, at a processor, a configuration data from a user comprising information about a warehouse and one or more stores;
determining, at the processor, variations in demand pattern and variations in frequency pattern of the one or more stores;
calculating, at a processor, a weighted score based on the determined variations;
dynamically selecting, at the processor, at least one of plurality of models based on the calculated weighted score;
generating, at the processor, a dispatch schedule for the warehouse by executing the selected at least one of the plurality of customized models; and
graphically displaying, by the processor, the determined dispatch schedule at a computing device of the user.

12. The non-transitory computer readable medium of claim 11, wherein the plurality of customized models comprises a genetic model, a heuristic model, and a mixed linear programming model.

13. The non-transitory computer readable medium of claim 11, wherein the selected at least one of the plurality of customized models is the genetic model, wherein the determining the dispatch schedule for the warehouse, comprising:
composing, at the processor, one or more chromosomes for plurality of combination of a delivery pattern and a quantity of inventory to be delivered from the warehouse to the one or more stores;
identifying, at the processor, a best fit chromosome from the one or more chromosomes by:
generating, at the processor, one or more offspring of the one or more chromosomes; and
eliminating, at the processor, one or more mutated chromosomes from the one or more chromosomes; and
displaying, by the processor, the delivery pattern and the quantity of inventory of the best fit chromosome as a dispatch schedule to the user.

14. The non-transitory computer readable medium of claim 13, wherein the delivery pattern for the one or more chromosomes is at least one of plurality of combinations comprising, at least one store, at least one warehouse and a frequency of delivery of inventory.

15. The non-transitory computer readable medium of claim 11, wherein the configuration data comprises a count of number of stores, a count of number of warehouses, a warehouse-store mapping information and a forecasted demand for each of the one or more stores for a horizon.
